(19) United States
(12) Patent Application Publication
(10) Pub. No.: US 2006/0032046 A1
(43) Pub. Date: Feb. 16, 2006

(54) Thin-film cathode for 3-dimensional microbattery and method for preparing such cathode

(76) Inventors: Menachem Nathan, Tel Aviv (IL); Emanuel Peled, Even Yehuda (IL); Diana Golodnitsky, Rishon Letzion (IL); Vladimir Yufit, Ashdod (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/531,529

(22) PCT Filed: Jul. 29, 2003
(86) PCT No.: PCT/IL03/00623

§ 371 Date: Jun. 27, 2005

Related U.S. Application Data
(60) Provisional application No. 60/418,718, filed on Oct. 17, 2002.

(51) Int. Cl. H01M 10/04; H01M 6/12; H01M 4/58

(52) U.S. Cl. 29/623.5; 429/162; 429/220; 429/231.5; 429/218.1

(57) ABSTRACT

A method for producing a microbattery including providing a conductive substrate, forming a thin film cathodic layer on at least one surface of the conductive substrate, subsequently forming a thin film electrolyte layer over the cathodic layer and subsequently forming a thin film anodic layer over the electrolyte layer

### REFERENCE TO CO-PENDING APPLICATION

This application claims priority from U.S. Provisional Patent Application Ser. No. 60/418,718, filed Oct. 17, 2002 and entitled “THIN-FILM CATHODE FOR 3-DIMENSIONAL MICROBATTERY AND METHOD FOR PREPARING SUCH CATHODE”.

### FIELD OF THE INVENTION

This invention relates in general to thin-film batteries. More specifically, the invention relates to a method for producing thin-film microbatteries having a 3-D structure and cathodes therefor, and the microbatteries and cathodes obtained by such method.

### BACKGROUND OF THE INVENTION

The following references are considered to be pertinent for the purpose of understanding the background of the present invention:

A. Albu-Yaron et al., Thin Solid Films 361-362 (2000) 223-228;

Bates et al., U.S. Pat. No. 5,338,625;

Bates et al., U.S. Pat. No. 5,567,210;

Becker et. al., U.S. Pat. No. 6,214,161;

J. J. Devadasan et al., Journal of Crystal Growth 226 (2001) 67-72;

P. Fragnaud et al., Journal of Power Sources 54 (1995) 362-366;

Laermer et al, U.S. Pat. Nos. 5,498,312 and 6,303,512;

I. Martin-Litas et al., Journal of Power Sources 97-98 (2001), 545-547;

Y. Mild et al., Journal of Power Sources 54 (1995) 508-510;

Nathan et al., U.S. Pat. No. 6,197,450;

Norma R. de Tacconi et al., J. Phys. Chem. (1996), 100, 18234-18239;

E. A. Ponomarev et al., Thin Solid Films 280 (1996) 86-89.

There is a global race to develop miniaturized power sources for applications including implantable medical devices, remote sensors, miniature transmitters, smart cards, and MEMS (micro-electro-mechanical-system) devices. Thin film lithium batteries are the leading candidates today, but the existing planar technology has limitations, such as low energy density.

In thin-film battery technology the battery cell components can be prepared as thin, e.g. 1 micron, sheets built up in layers. The anode, the electrolyte and the cathode are in the form of thin films. Consequently, the anode is located close to the cathode, resulting in high current density, high cell efficiency and reduction in the amount of reactants used.

The capacity of a thin-film battery is directly proportional to the area and thickness of the anode-electrolyte-cathode layers that form it. U.S. Pat. No. 6,197,450 describes a method of increasing the capacity of thin-film electrochemical devices by increasing the surface-to-volume ratio of the substrate upon which the layered thin-film structure is deposited. This is accomplished by etching the battery substrate to form an array of variably shaped through-holes. The use of such a substrate increases the available area for thin film deposition, thus leading to an increase in volume, i.e. capacity of the cell. U.S. Pat. No. 6,197,450 also describes a 3-dimensional (3-D) thin-film micro-battery with layers deposited inside the holes and on both flat surfaces of the substrate.

Several studies on cathode materials have been performed to improve the electrochemical performances of micro-batteries used in microelectronic devices. Some well-known materials used as the cathode (positive electrode) in lithium-ion batteries are LiMn₂O₄, V₂O₅, LiCoO₂ and TiS₂, which have been prepared in the form of a thin-film by various deposition methods.

U.S. Pat. Nos. 5,338,625 and 5,567,210 disclose a novel vanadium oxide cathode and use of physical deposition techniques such as rf or dc magnetron sputtering for the fabrication of thin-film lithium cells, especially thin-film micro-batteries having application as backup or primary integrated power sources for electronic devices. The batteries are assembled from solid-state materials, and can be fabricated directly onto a semiconductor chip, a chip package or a chip carrier.

Others have disclosed methods of preparing different cathode materials. For example, P. Fragnaud et al. disclose a method of preparing a thin-film made of LiCoO₂ or LiMn₂O₄ for use as cathodes in secondary lithium batteries. These films were prepared by chemical techniques such as CVD (chemical vapor deposition) and spray pyrolysis.

Also, I. Martin-Litas has disclosed the preparation of tungsten oxysulfide (WO_{y}S₂) thin films by reactive radio frequency magnetron sputtering.

Preparation of a polycrystalline tungsten disulfide thin film by electrodeposition on conducting glass plates in galvanostatic route was described by J. J. Devadasan et al. The obtained film was used for photoelectrochemical solar cells.

A MoS₂ cathode material for lithium secondary batteries was synthesized by Y. Miki et al. by using thermal decomposition of (NH₄)₂MoS₄ in a hydrogen gas flow at temperatures from 150 to 300° C. MoS₂ thin films were also prepared by electrochemical deposition by reduction of tetrathiomolybdate ions, as described by E. A. Ponomarev and A. Albu-Yaron. According to these publications MoS₂ may be used for various applications such as solar cells, solid lubricants and rechargeable batteries.

Copper sulfide is useful in solar cells and in potentiometric sensor devices. Chemical sulfidisation of copper was described by N. R. de Tacconi et al, where the formation of copper sulfide films at copper anodes was accomplished in sulfide containing aqueous NaOH media.

Most of the known methods for the formation of thin films for battery applications, including physical methods, such as sputtering and spray pyrolysis, require flat surfaces and are therefore unsuitable for “conformal”, three-dimensional (3-D) structures in which the deposited films have to follow a surface's contour. Thus, present deposition methods are unacceptably disadvantageous for the production of 3-D thin film batteries.

### SUMMARY OF THE INVENTION

The present invention seeks to provide a method for producing thin-film microbatteries having a 3-D structure and cathodes therefor, and the microbatteries and cathodes obtained by such method.

There is thus provided in accordance with a preferred embodiment of the present invention a method for producing a microbattery including providing a conductive substrate, forming a thin film cathodic layer on at least one surface of the conductive substrate, subsequently forming a thin film electrolyte layer over the cathodic layer and subsequently forming a thin film anodic layer over the electrolyte layer.

Preferably, the forming a cathodic layer includes electrochemically forming the cathodic layer.

There is also provided in accordance with another preferred embodiment of the present invention a method for producing a thin film cathode including providing a conductive substrate and electrochemically forming a thin film cathodic layer on at least one surface of the conductive substrate.

In accordance with another preferred embodiment of the present invention the cathodic layer includes at least one material selected from the group consisting of sulfides of a transition metal, oxides of a transition metal and mixtures of the sulfides and the oxides.

In accordance with yet another preferred embodiment of the present invention the providing includes providing a non-conductive substrate and forming a conductive layer on at least one surface of the non-conductive substrate. Preferably, the forming a conductive layer includes electrolessly depositing a conductive material on the surface of the non-conductive substrate. Additionally, the conductive material includes at least one material selected from the group consisting of Cu, Ni, Co, Fe, Au, Ag, Pd, Pt and their alloys.

In accordance with another preferred embodiment of the present invention the method also includes providing a plurality of cavities in the substrate, the cavities having an arbitrary shape and having an aspect ratio greater than 1 and depositing the cathodic layer, the electrolyte layer and the anodic layer between the cavities and throughout the inner surfaces of the cavities. Preferably, the cathodic layer, the electrolyte layer and the anodic layer are continuous. Additionally or alternatively, the cavities have an aspect ratio of between 2 to about 50. In accordance with another preferred embodiment of the present invention the cavities have a cylindrical geometry.

In accordance with another preferred embodiment of the present invention the substrate includes at least one material selected from the group consisting of glass, alumina, semiconductor materials, ceramic materials, organic polymers, inorganic polymers and glass-epoxy composites. Additionally, the substrate includes silicon.

In accordance with another preferred embodiment of the present invention the cathodic layer includes at least one material selected from the group consisting of Cu₂S, MoS₂, CoₓS_{y} where x=1-4 and y=1-10, CoₘOₙ where m=1-2 and n=1-3, WS₂, and mixtures thereof.

There is further provided in accordance with another preferred embodiment of the present invention a microbattery including a conductive substrate, a thin film cathodic layer formed on at least one surface of the conductive substrate, a thin film electrolyte layer formed over the cathodic layer and a thin film anodic layer formed over the electrolyte layer.

Preferably, the cathodic layer includes an electrochemically formed cathodic layer.

There is yet further provided in accordance with another preferred embodiment of the present invention a thin film cathode including a conductive substrate and a thin film cathodic layer electrochemically formed on at least one surface of the conductive substrate.

In accordance with another preferred embodiment of the present invention the cathodic layer includes at least one material selected from the group consisting of sulfides of a transition metal, oxides of a transition metal and mixtures of the sulfides and the oxides.

In accordance with another preferred embodiment of the present invention the conductive substrate includes a non-conductive substrate and a conductive layer formed over at least one surface of the non-conductive substrate. Preferably, the conductive layer includes a conductive material electrolessly deposited on the surface of the non-conductive substrate. Additionally, the conductive layer includes at least one material selected from the group consisting of Cu, Ni, Co, Fe, Au, Ag, Pd, Pt and their alloys.

In accordance with another preferred embodiment of the present invention the microbattery also includes a plurality of cavities formed in the substrate, the cavities having an arbitrary shape and having an aspect ratio greater than 1 and the cathodic layer, the electrolyte layer and the anodic layer are deposited between the cavities and throughout the inner surfaces of the cavities. Additionally, the cathodic layer, the electrolyte layer and the anodic layer are continuous. Additionally or alternatively, the cavities have an aspect ratio of between 2 to about 50. In accordance with another preferred embodiment of the present invention the cavities have a cylindrical geometry.

In accordance with another preferred embodiment of the present invention the substrate includes at least one material selected from the group consisting of glass, alumina, semiconductor materials, ceramic materials, organic polymers, inorganic polymers and glass-epoxy composites. Preferably, the substrate includes silicon.

In accordance with another preferred embodiment of the present invention the cathodic layer includes at least one material selected from the group consisting of Cu₂S, MoS₂, CoₓS_{y} where x=1-4 and y=1-10, COₘOₙ where m=1-2 and n=1-3, WS₂, and mixtures thereof.

### BRIEF DESCRIPTION OF THE DRAWINGS

The present invention will be understood and appreciated more fully from the following detailed description, taken in conjunction with the drawings in which:

FIG. 1 is a simplified pictorial and sectional illustration of a microbattery constructed and operative in accordance with a preferred embodiment of the present invention;

FIG. 2 is a SEM of a Cu₂S layer on a flat, silicon substrate coated with a Cu layer;

FIG. 3 is an XRD of Cu₂S on silicon substrate coated with a Cu layer;

FIG. 4 is a graph of charge-discharge curves of a Li/CPE/Cu₂S microbattery at 120° C.;

FIG. 5 is a graph of capacity loss of Li/CPE/Cu₂S microbattery;

FIG. 6 is a SEM of MoS₂ on silicon substrate covered with a Ni layer;

FIG. 7 is a graph of charge-discharge curves of a Li/HPE/MoS₂ microbattery at room temperature;

FIG. 8 is a graph of capacity loss of a Li/HPE/MoS₂ microbattery;

FIG. 9 is graph of capacity loss of a Li-ion/HPE/MoS₂ microbattery;

FIG. 10 is a graph of charge-discharge curves of Li/CPE/MoS₂ microbattery at 120° C.;

FIG. 11 is a graph of capacity loss of a Li/CPE/MoS₂ microbattery; and

FIG. 12 is a graph of charge/discharge curves of a Li-ion/HPE/CoS microbattery.

### DETAILED DESCRIPTION OF THE INVENTION

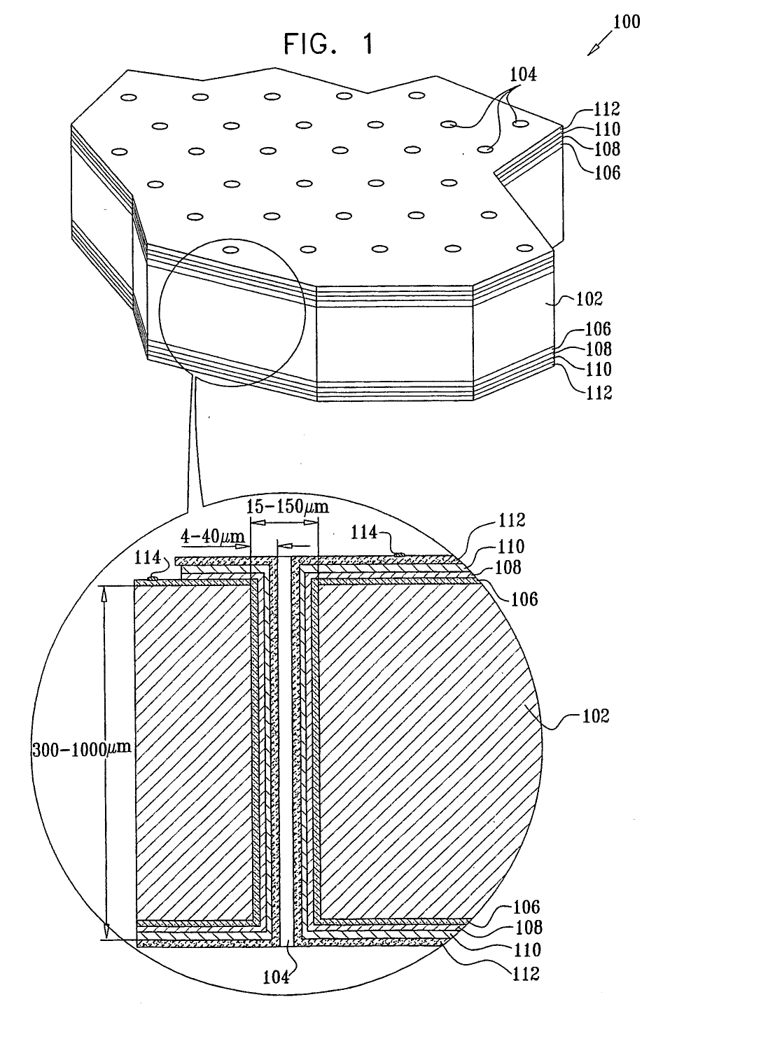

Reference is now made to FIG. 1, which is a simplified pictorial and sectional illustration of a microbattery constructed and operative in accordance with a preferred embodiment of the present invention. As seen in FIG. 1, microbattery 100 includes a substrate 102, such as a silicon substrate, typically with a thickness of between 300 and 1000 μm. Substrate 102 is preferably provided with a plurality of cavities 104 formed therethrough. Cavities 104 are typically formed by photolithography and deep reactive ion etching (DRIE) as described further hereinbelow. Substrate 102 and cavities 104 are then preferably coated with a conductive substance to form a thin film current collector layer 106, as described hereinbelow. Alternatively, substrate 102 may be formed of a conductive material and the formation of current collector layer 106 may be obviated.

The substrate 102 and cavities 104 are subsequently coated with a thin film cathodic layer 108. A thin film electrolyte layer 110 and a thin film anodic layer 112 are then formed over cathodic layer 108. The thin film layers 108, 110 and 112 are typically in the range of 1-10 μm thick, and the cavities are typically in the range of 15-150 μm in diameter. Contacts 114 are typically formed on the current collector layer 106 and the anodic layer 112.

In one example of a microbattery constructed and operative in accordance with the present invention, a 440 μm thick, 3″ diameter, double side polished (100) silicon wafer was coated on one side with about 11 μm of AZ-4562 photoresist. Arrays of square holes with a side dimension of 80 μm and inter-hole spacing of about 220 μm were then defined by photolithography. The sequence of photolithography steps includes:

1. Dehydration baking of wafer after cleaning for 2 min. at a temperature of 110° C. on a hot plate;

2. Dispensing photoresist and spinning at about 1400 RPM for 30 seconds;

3. Solvent removal baking at a temperature of 110° C. for 1 min. on a hot plate;

4. Exposure for between 17 to 22 seconds in a mask aligner;

5. Developing for 4-6 minutes in AZ-726 developer; and

6. Hard baking at a temperature of 110° C. for 3 minutes on the hot plate.

After photolithography, cavities were etched using DRIE in a Plasma-Therm SLR 770 ICP system using a standard Bosch process. Following the formation of cavities 104, the thin film layers 106, 108, 110 and 112 were formed.

There are two configurations of the high surface area, 3-dimensional “on-chip” microbattery (3D-MB). In a first configuration, hereinafter referred to as 3D-MB-1, the cathode material is deposited directly onto the silicon surface. In the second configuration, hereinafter referred to as 3D-MB-2, as described in U.S. Pat. No. 6,197,450, incorporated herein by reference, the anode material, such as lithium or carbon, is in electronic contact with the substrate. In this second configuration, an additional layer between the silicon surface and the carbon or lithium anode must be created in order to eliminate intercalation of Lithium ions into the bulk of the silicon at low voltage.

In accordance with a preferred embodiment of the present invention, a copper sulfide thin film cathode is deposited on a silicon substrate. In one example of this embodiment, the silicon substrate was pretreated in solutions of H₂O(5):H₂O₂(1):NH₄OH(1), H₂O(6):H₂O₂(1):HCl(1) at a temperature of 80-100° C. and in isopropanol, for removing oxides and organic contaminations. The sample was further wet-etched in a strong basic solution, rinsed in water and immediately immersed in a Pd-containing solution to increase the catalytic activity of the silicon substrate surface. Electroless deposition of copper on the silicon substrates was carried out in a CuSO₄/HCOH solution and resulted in a uniform copper thin film of 500-700 nm. The copper-deposited silicon samples were immersed into an electrolyte solution containing Cu²⁺ ions and surfactant materials. Electrochemical copper deposition was carried out at constant current density of 20-50 mA/cm² for a few minutes. A thicker layer of 5-20 microns of copper was formed on these silicon samples. This layer serves as the current collector layer. The copper-deposited silicon substrates were introduced into an aqueous solution of polysulfides (a mixture of 10 mM Na₂S, 0.1M NaOH and elemental sulfur) at room temperature and electrooxidized at a constant current of 0.1 mA/cm²-0.5 mA/cm² for a few seconds, forming a thin cathode layer, with a thickness of 1-3 microns, of crystalline Cu₂S (verified by XRD) on the copper-coated silicon. The copper electrode was cathodically polarized prior to Cu₂S film growth to reduce any residual oxide layer.

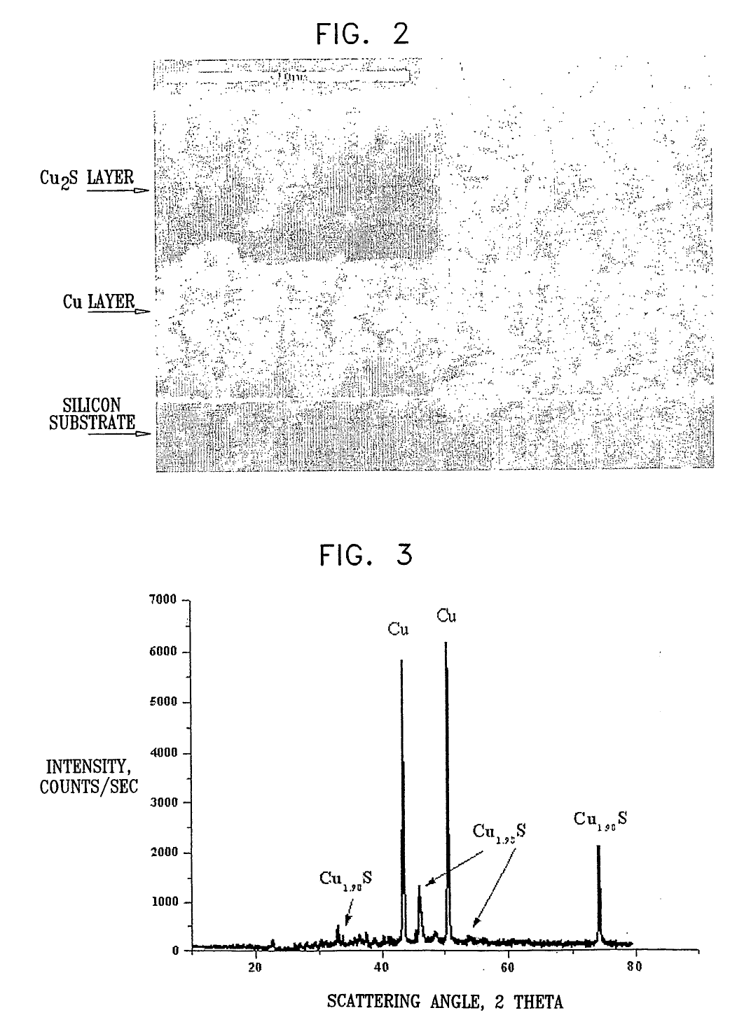

Reference is now made to FIG. 2, which shows a SEM cross-sectional view of the copper sulfide layer deposited onto a copper coated silicon wafer. The crack between Cu and Cu₂S layers, seen in the lower part of this image, is caused by quenching in liquid nitrogen, which was used for cross-section cutting of the cathode.

Reference is now made to FIG. 3, which shows the powder XRD analysis of the as-deposited films on silicon. The analysis reveals crystallographic peaks belonging to the deposited Cu layer and Cu₂S.

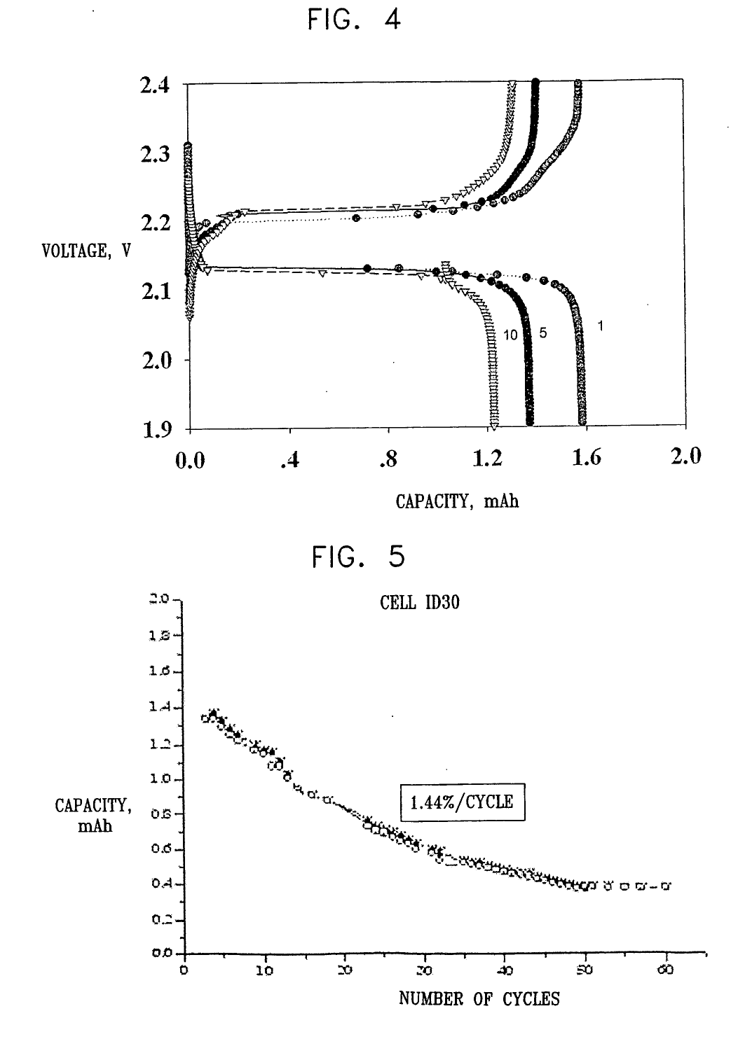

Reference is now made to FIGS. 4 and 5, which are, respectively, a graph of charge/discharge curves and capacity loss of the Cu2S/composite polymer electrolyte/lithium battery operating at 120° C. and current density of 50 mA/cm². As seen in FIG. 4, the charge/discharge curve is represented by a well-pronounced plateau at about 2.1V. The capacity loss of the battery is about 1.4%/cycle, as seen in FIG. 5.

In accordance with another preferred embodiment of the present invention, a thin film cathode of MOS₂ is obtained by cathodic reduction. In one example of this embodiment, a silicon substrate was electrolessly coated with a thin film of nickel, typically having a thickness of 200-300 nm, which serves as the current collector layer. The substrate was then immersed into a solution containing MoS₄²⁻ ions, and an ultra thin film of MoS₂, typically hazing a thickness of 300-600 nm, was formed by electroreduction of MoS₄²⁻ ions on the nickel-coated silicon substrate at a constant current density of 10-15 mA/cm².

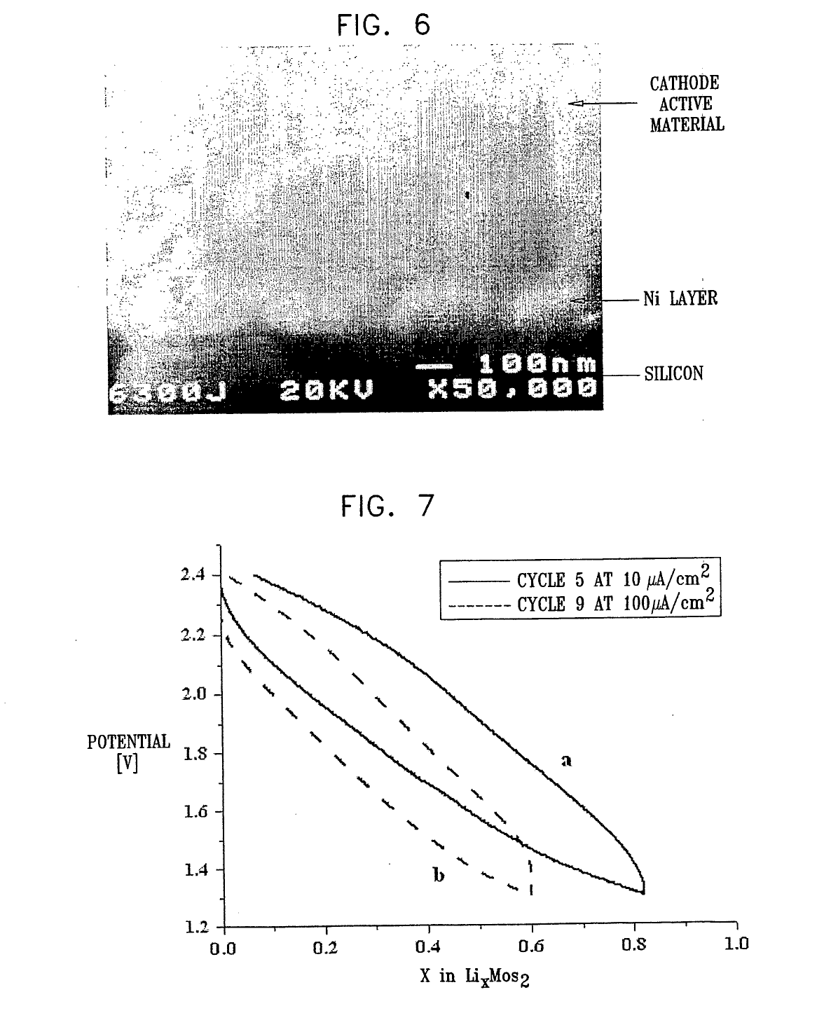

Reference is now made to FIG. 6, which is a SEM micrograph of a cross-section of the MoS₂ cathode deposited on a nickel-coated silicon substrate. A compact, highly adherent MoS₂ film with a thickness about 300 to 600 nm is built. The powder XRD analysis of the as-deposited film on nickel revealed crystallographic peaks belonging to the nickel substrate alone. This may indicate the formation of mainly amorphous MoS₂ deposits.

The formation of the microbattery of the present invention then comprises the deposition of an ion conductive electrolyte 110 over the already-deposited cathode layer 108. In the examples described hereinbelow, the electrolyte was formed by casting a soluble polymer mixture directly onto the cathode. In the examples described hereinbelow, two types of conductive separators were used. The first type was a composite polymer electrolyte based on a polyethylene oxide, a lithium salt, such as lithium imide, “triflat” or lithium bis-oxaloborate, and alumina or silica nanoparticles. The second type was a so called hybrid gel-polymer electrolyte (HPE) based on a nanoporous membrane of polyvinylidene flouride soaked with a lithium salt, such as LiPF₆ or Li-Imide, dissolved in an ethylene carbonate: diethylcarbonate (EC:DEC) electrolyte. Solvents, such as diglyme (DG), tetraglyme (TG) and polyethylene glycol dimethyl ether (PEGDME, MW 500), can be used in HPEs as well.

Reference is now made to FIGS. 7-11, which are graphs showing the performance characteristics of various microbatteries constructed and operative in accordance with preferred embodiments of the present invention. FIG. 7 shows a graph of typical charge-discharge curves of a Li/HPE/MoO_{y}S_{z} cell, with the cathode deposited on a nickel substrate. The cell was cycled at room temperature and i_{d}=i_{ch}=10 μA/cm². The sloping character of the curves is typical of an insertion/de-insertion process into a single-phase host material according to the following reaction:
MoO_{y}S_{z}+xLi+→LiₓMoO_{y}S_{z}

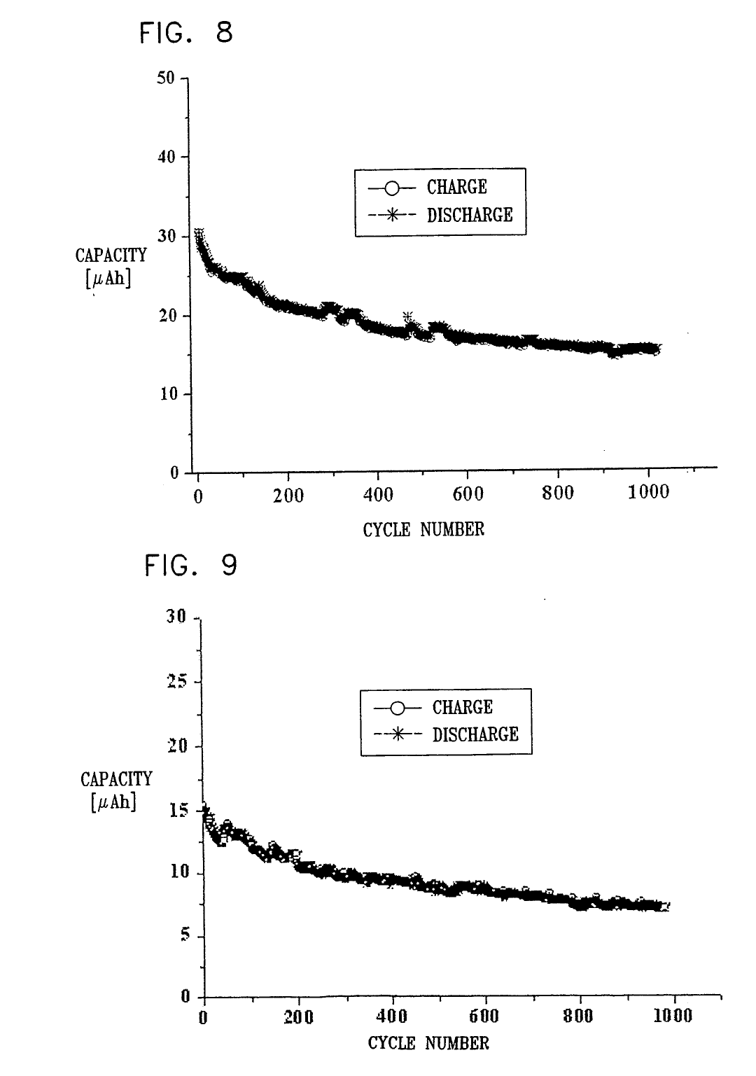

It is to be emphasized that an up to ten-fold increase in the current density did not influence either the shape of the curves (curve b, in comparison to curve a), nor the degradation rate. About 0.8 and 0.6 mole atoms of lithium were reversibly intercalated at low and high current density, respectively. The 1^{st} cycle utilization of the cathode active material approached 85%. The Li/HPE/MoO_{y}S_{z} cell ran over 1000 successive cycles with 0.05%/cycle capacity loss and 100% Faradaic efficiency, as shown in FIG. 8.

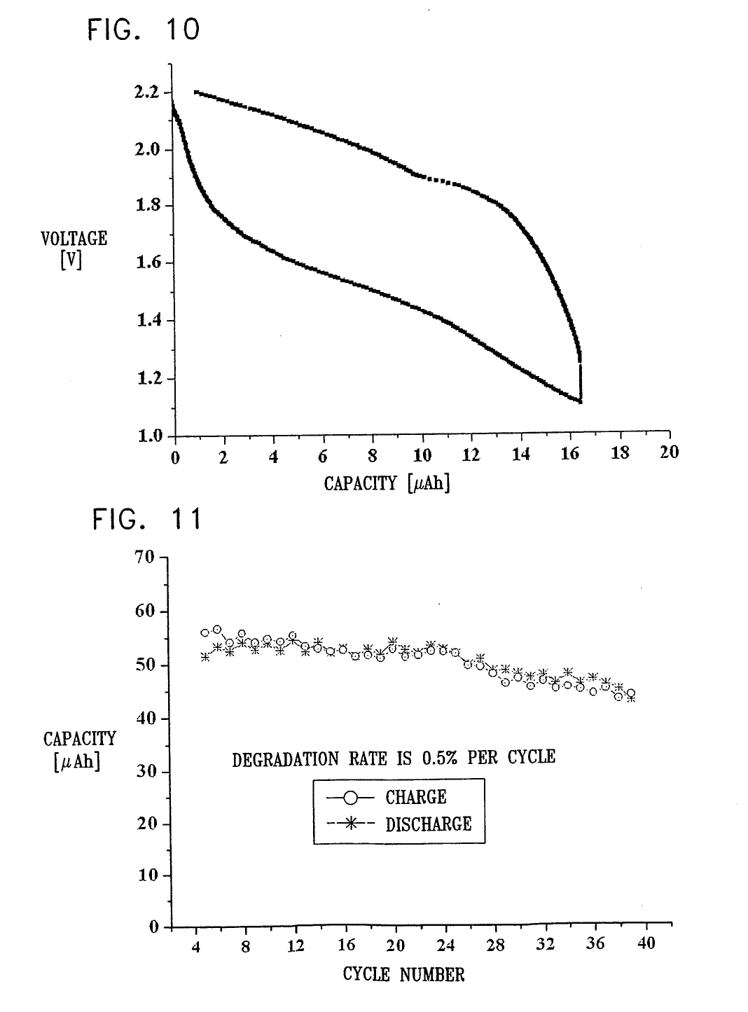

FIG. 9 is a graph showing the capacity loss and charging efficiency of a Li-ion/HPE/MoS₂ cell, with the cathode deposited on a nickel coated silicon substrate. The cell was cycled at room temperature and a 100 μA/cm² rate. As can be seen in FIG. 9, during more than 1000 reversible 100% DOD cycles the degradation rate did not exceed 0.05%/cycle and the Faradaic efficiency was close to 100%.

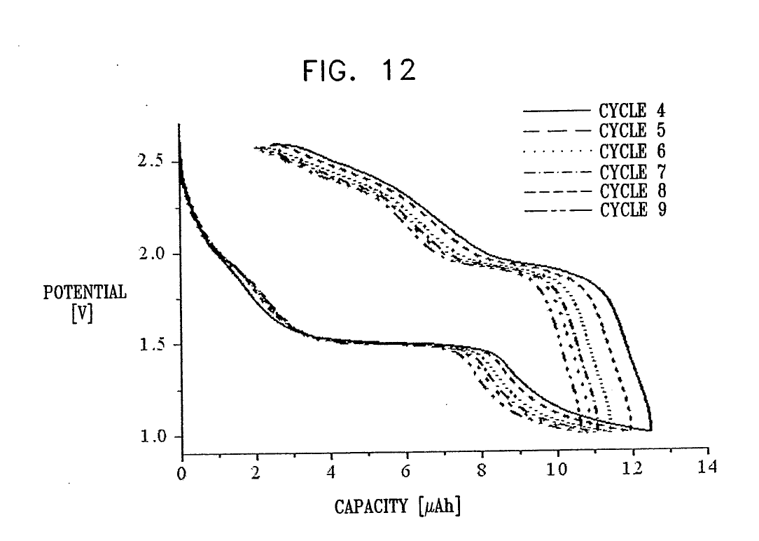

FIG. 10 shows the charge/discharge of a Li/LiImide₁P(EO)₂₀EC₁ 12% (v/v) Al₂O₃/MoS₂ cell carried out at 125° C. While the same charge-discharge mechanism was expected in this electrochemical system, the degradation degree in the Li/CPE/MoS₂ cell was 0.5%/cycle, as seen in FIG. 11, which was higher than in the HPE-consisting battery. This may be caused by poor contacts and insufficient ionic mobility in the all-solid-state battery. It is noteworthy that no self-discharge was detected in all the Li/MoS₂ cells under investigation. Slow overdischarge to 0.2V does not affect the subsequent cycling behavior of the Li/MoS₂ batteries.

A known method for improving the performance characteristics of a battery is the formation of a protective layer, typically in the form of a very thin ion-conductive protective film, known as a solid electrolyte interphase (SEI), over the pyrite particles of the cathode layer. The formation of the SEI provides protection to the cathode active material in fully charged and/or fully discharged states and improves the performance characteristics of the battery. To achieve high performance characteristics in the lithium and Li-ion batteries, the SEI must be an electronic resistor and an ionic conductor. In accordance with another embodiment of the present invention, a SEI is built in situ as a solid ion-conducting electrolyte in the 3D-microbattery. The SEI is electrochemically formed by overdischarge of the cell during the first cycle or during the first few cycles. This procedure may also be carried out during electrochemical lithiation of graphite in Li-ion batteries.

For a lithium battery, a metallic lithium electrode was used as the anode material. For lithium-ion applications, additional casting of lithiated graphite particles with polymer used as a binder is needed. In accordance with another embodiment of the present invention, a microbattery is formed by depositing an anode layer directly on the current collector layer. In this embodiment, the anode is formed by electrochemical deposition of an anode material, such as SnₓSb_{y}, onto the first layer of the current collector, or by chemical vapor deposition of a carbonaceous precursor on nickel-deposited silicon, where the nickel coating acts as a catalyst. This is followed by successive formation of a soft carbon layer that serves as the anode for lithium-ion batteries.

For the three-dimensional batteries of both the 3D-MB-1 structure, in which the cathode material is deposited directly onto the substrate surface, and the 3D-MB-2 structure, where the anode material is in electronic contact with the substrate, the filling of cylindrical holes of the perforated silicon by HPE and lithiated graphite can be performed by spinning and/or vacuum pooling.

The following are additional examples of microbatteries with electrochemically deposited cathodes, constructed and operative in accordance with further embodiments of the present invention, and their performance. One example is a planar thin film Li/copper sulfide-on silicon battery with a solid polymer and gel electrolyte was cycled at 120° C. and at room temperature. The degree of degradation of both cells was in the range of 1.5-2.5%/cycle. The capacity loss of a Li/solid polymer electrolyte/mixed cobalt cathode cell was about 3%/cycle. In another example, a planar 1 cm² Li/gel polymer electrolyte/molybdenum sulfide cell went through over 1000 reversible cycles with a capacity loss of less than 0.1%/cycle at room temperature. In a further example, a 3D Li-ion/HPE/MoS₂ battery went over 50 reversible cycles with capacity loss of about 0.5%/cycle.

Microbatteries routinely go more than 100 cycles. The thin-film Cu₂S/Li battery can operate both at room temperature and at a temperature of 120° C. The cell delivers a rechargeable capacity of 160 mAh/g with a flat potential plateau at ca. 1.6V vs. Li/Li⁺.

### EXAMPLE 1

A secondary electrochemical cell, consisting of a lithium anode, a hybrid polymer electrolyte and a MoS₂ cathode on a silicon substrate, was assembled.

To remove organic and metallic residues, the silicon substrate was immersed in a solution of H₂O₂:NH₄OH for 5 min at 70° C. and washed in deionized water with successive immersion into a H₂O₂:HCl mixture for another 5 min. After rinsing in deionized water, the substrate was etched in a NH₄F:HF solution for 2 min. The surface activation was accomplished in a PdCl₂:HCl:HF:CH₃COOH solution at room temperature for 2 min.

A 0.3 μm thick cathode was prepared by reduction of MoS₄²⁻ ions on a nickel coated silicon substrate at a constant current density of 10-15 mA/cm². The nickel deposition was carried out in a NiSO₄:NaH₂PO₂:EDTA (or CH₃COONa) solution with pH of 4 and at an elevated temperature of 90° C. for a few minutes. The thickness of the nickel deposited is a function of time and can be varied.

The deposition of the MoS₂ was carried out using an aqueous solution of 0.05M tetrathiomolybdate. A potassium chloride (0.1 M) electrolyte was the supporting electrolyte. The electrodeposition was carried out at room temperature using a constant current density of 10 mA/cm² for 4 min. The deposited samples were thoroughly rinsed in deionized water and vacuum-dried at an elevated temperature.

SEM micrographs reveal that the films deposited at room temperature are fairly continuous without visible cracks. EDS measurements showed 1:2 Mo:S ratio. XPS data supported this composition. The films were X-ray transparent, indicating an amorphous structure of MoS₂.

The preferred polymer for the hybrid polymer electrolyte (HPE) is a commercially available PVDF-2801 copolymer (Kynar). The PVDF powder was dissolved in high-purity cyclopentanone (Aldrich). Fumed silica 130 (Degussa) and propylene carbonate (PC, Merck), were added and the mixture was stirred at room temperature for about 24 hours to get a homogeneous slurry. After complete dissolution, the slurry was cast on the Teflon support and spread with the use of the doctor-blade technique. To prevent surface irregularities, the film was then covered with a box with holes to allow a slow evaporation of the cyclopentanone. After complete evaporation of the cyclopentanone, a 13 mm diameter disc was cut from the polymer membrane. The disc was then soaked in a LiImide-based electrolyte for 48 hours. At least three fresh portions of electrolyte were used for each soaking to ensure a complete exchange of the PC by the electrolyte. LiImide-ethylene carbonate (EC):dimethyl carbonate (DMC) 1:1 (v/v) based electrolytes were stored in a glove box with Li chips.

The Li/HPE/MoS₂ cells were cycled at room temperature using a Maccor series 2000 battery test system. The voltage cut-off was 1.3 to 2.4 V, and the charge/discharge current density was 10-100 μA/cm². The Li/HPE/MoS₂ cell delivered above 20 μAh per cycle at 100 μA/cm² (FIG. 8) for over 1000 reversible cycles with the capacity fade of 0.05%/cycle. The Faradaic efficiency was close to 100%.

### EXAMPLE 2

A Li/composite polymer electrolyte (CPE)/MoS₂ battery was assembled. The cathode was prepared as in Example 1.

A 50 μm thick film composite polymer electrolyte with a composition of LiImide₁ P(EO)₂₀ EC₁ 9% v/v Al₂O₃ was prepared from 45 mg LiImide, 300 mg P(EO), 30 mg EC and 100 mg Al₂O₃.

Poly(ethylene oxide) (P(EO)) was purchased from Aldrich, (average molecular weight 5×10⁶) and was vacuum dried at a temperature of 45 to 50° C. for about 24 hours. A polymer slurry was prepared by dispersing known quantities of P(EO), LiImide, and ethylene carbonate (EC) in analytical grade acetonitrile, together with the required amount of an inorganic filler, such as Al₂O₃ (Buehler) with an average diameter of about 150 A. To ensure the formation of a homogeneous suspension, an ultrasonic bath or high-speed homogenizer was used. The suspension was stirred for about 24 hours before the PE films were cast on the fine polished Teflon support (64 cm² area). The solvent was allowed to evaporate slowly and then the films were vacuum dried at 120° C. for at least 5 hours. The final thickness of the solvent-free PE films was between 30 to 50 μm thick.

The Li/composite polymer electrolyte (CPE)/MoS₂ battery was cycled at a temperature of 120° C. and a current density of 50 mA/cm². The voltage cutoff on discharge was 1.1 V. The voltage cutoff on charge was 2.2 V (FIG. 10). The cell went through over 40 reversible cycles (100% DOD), and the degree of degradation did not exceed 0.5%/cycle (FIG. 11).

### EXAMPLE 3

A Li/CPE/Cu₂S cell with a 1 μm thick film composite cathode was prepared and assembled as described in Example 1, using the following materials: 33 mg LiI, 216 mg P(EO), 41 mg EC, 100 mg Al₂O₃. A 100% dense Cu₂S cathode was prepared by anodic oxidation of a metallic copper layer electrodeposited on the electroless copper. The silicon substrate was pretreated, in solutions of H₂O(5):H₂O₂(1):NH₄OH(1), H₂O(6):H₂O₂(1):HCl(1) at temperatures of 80-100° C. and in isopropanol, to remove oxides and organic contaminations. The sample was further wet-etched in a strong basic solution, then rinsed in water and immediately immersed in a Pd-containing solution to increase the catalytic activity of the silicon substrate surface. The solution for electroless copper deposition consisted of (g/L): 10-15 CuSO₄x5H₂O, 10-15 NaOH, 2-3 NiCl₂xH₂O, 0.001 Na₂S₂O₈, 15-25 mL/L HCOH (37%).

The electrolyte for copper electrodeposition contained (g/L): 200-250 CuSO₄x5H₂O and 50-60 H₂SO₄. The electrodeposition was performed at room temperature and a current density of 50 mA/cm² for 8 min. The copper layer thus formed was electrooxidised in an aqueous solution of polysulfides, consisting of a mixture of 10 mM Na₂S, 0.1M NaOH and elemental sulfur, at a constant current of 0.1 mA/cm²-0.5 mA/cm² for a few seconds. A SEM micrograph of the silicon-copper-copper sulfide layers is shown in FIG. 2. XRD data affirming the obtaining of a Cu₂S compound is shown in FIG. 3.

The Li/CPE/Cu₂S cell went through over 50 reversible cycles, and the degree of degradation did not exceed 1.5%/cycle, as seen in FIGS. 4 and 5.

### EXAMPLE 4

A Li/HPE/Cu₂S cell with a 1 μm thick film cathode was prepared and assembled as described in Examples 2 and 3. The cell went through over 120 reversible cycles (100% DOD), with the degree of degradation being 0.8%/cycle.

### EXAMPLE 5

A Li/CPE/WS₂ cell with a 0.4 μm thick film composite cathode was prepared as described in Example 2. The cell went through over 135 reversible cycles (100% DOD), and the degree of degradation did not exceed 0.2%/cycle.

### EXAMPLE 6

A Li/CPE/Cu₂S cell with a 2 μm thick film composite cathode with a Li₂S₆ to LiI ratio of 1:0.25 was assembled as described in Example 3. The Li/CPE/Cu₂S cell was cycled for over 40 (100% DOD) cycles.

### EXAMPLE 7

A Li/CPE/CoₓS_{y} cell with a 0.3 μm thick film composite cathode was assembled as described in Example 3. A 100% dense CoₓS_{y} cathode was prepared by electrochemical oxidation of metallic Co in the solution of polysulfides. The Li/CPE/CoₓS_{y} cell was cycled for over 30 (100% DOD) cycles (FIG. 12).

### EXAMPLE 8

A lithium-ion/MoS₂ cell with a 0.5 μm thick film cathode and a hybrid polymer electrolyte was prepared according to the procedure of Example 1. The HPE was formed, by casting, on a cathode layer deposited on a silicon substrate. The lithiation of graphite powder was carried out as follows:

1. A polymer binder (polystyrene) was dissolved in toluene. After dissolution, a graphite powder, with an average particle size of a few μm, was added to the mixture. The resulting slurry was spread on a copper current collector by doctor blade.

2. This electrode was vacuum dried and assembled with lithium and ion-conductive separator (Celgard soaked in 1M LiPF6 EC:DEC 1:1 v/v) in cells.

3. After a few successive cycles, the cells were disassembled and the lithiated electrode was rinsed in DMC and vacuum dried.

The lithiated graphite electrodes were used as anodes in Li-ion/HPE/MoS₂ on-silicon battery. The battery was reversibly charged-discharged for over 1000 cycles with capacity loss of 0.06%/cycle. The Faradaic efficiency was close to 100%. The battery delivered about 10 μAh per cycle (FIG. 9).

### EXAMPLE 9

A 3D-lithium-ion/MoS₂ cell, with a 0.3 μm thick film cathode and a hybrid polymer electrolyte, was prepared according to the procedures of Examples 1 and 8. The electrodeposition was performed in a 0.05M tetrathiomolybdate electrolyte. Lithiated graphite (see Example 8) was peeled from the copper electrode and introduced into a toluene solution. A few hours of stirring produced a homogenous mixture of lithiated graphite and binder in toluene. The cylindrical holes of the perforated silicon were filled with HPE and lithiated graphite by spinning. The battery was reversibly charged-discharged for 50 cycles and delivered 35 μAh per cycle. The Faradaic efficiency was close to 100%.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A method for producing a microbattery comprising:
providing a conductive substrate;
forming a thin film cathodic layer on at least one surface of said conductive substrate;
subsequently forming a thin film electrolyte layer over said cathodic layer; and
subsequently forming a thin film anodic layer over said electrolyte layer.

2. A method according to claim 1 and wherein said forming a cathodic layer comprises electrochemically forming said cathodic layer.

3. A method according to claim 1 and wherein said cathodic layer comprises at least one material selected from the group consisting of sulfides of a transition metal, oxides of a transition metal and mixtures of said sulfides and said oxides.

4. A method according to claim 1 and wherein said providing comprises:
providing a non-conductive substrate; and
forming a conductive layer on at least one surface of said non-conductive substrate.

5. A method according to claim 4 and wherein said forming a conductive layer comprises electrolessly depositing a conductive material on said surface of said non-conductive substrate.

6. A method according to claim 5 and wherein said conductive material comprises at least one material selected from the group consisting of Cu, Ni, Co, Fe, Au, Ag, Pd, Pt and their alloys.

7. A method according to claim 1 and also comprising:
providing a plurality of cavities in said substrate, said cavities having an arbitrary shape and having an aspect ratio greater than 1; and
depositing said cathodic layer, said electrolyte layer and said anodic layer between said cavities and throughout the inner surfaces of said cavities.

8. A method according to claim 7 and wherein said cathodic layer, said electrolyte layer and said anodic layer are continuous.

9. A method according to claim 7 and wherein said cavities have an aspect ratio of between 2 to about 50.

10. A method according to claim 7 and wherein said cavities have a cylindrical geometry.

11. A method according to claim 1 and wherein said substrate comprises at least one material selected from the group consisting of glass, alumina, semiconductor materials, ceramic materials, organic polymers, inorganic polymers and glass-epoxy composites.

12. A method according to claim 1 and wherein said substrate comprises silicon.

13. A method according to claim 1 and wherein said cathodic layer comprises at least one material selected from the group consisting of Cu₂S, MoS₂, COₓS_{y} where x=1-4 and y=1-10, CoₘOₙ where m=1-2 and n=1-3, WS₂, and mixtures thereof.

14. A method for producing a thin film cathode comprising:
providing a conductive substrate; and
electrochemically forming a thin film cathodic layer on at least one surface of said conductive substrate.

15. A method according to claim 14 and wherein said cathodic layer comprises at least one material selected from the group consisting of sulfides of a transition metal, oxides of a transition metal and mixtures of said sulfides and said oxides.

16. A method according to claim 14 and wherein said providing comprises:
providing a non-conductive substrate; and
forming a conductive layer on at least one surface of said non-conductive substrate.

17. A method according to claim 16 and wherein said forming a conductive layer comprises electrolessly depositing a conductive material on said surface of said non-conductive substrate.

18. A method according to claim 17 and wherein said conductive material comprises at least one material selected from the group consisting of Cu, Ni, Co, Fe, Au, Ag, Pd, Pt and their alloys.

19. A method according to claim 14 and also comprising:
providing a plurality of cavities in said substrate, said cavities having an arbitrary shape and having an aspect ratio greater than 1; and
depositing said cathodic layer between said cavities and throughout the inner surfaces of said cavities.

20. A method according to claim 19 and wherein said cathodic layer is continuous.

21. A method according to claim 19, wherein said cavities have an aspect ratio of between 2 to about 50.

22. A method according to claim 19, wherein said cavities have a cylindrical geometry.

23. A method according to claim 14 wherein said substrate comprises at least one material selected from the group consisting of glass, alumina, semiconductor materials, ceramic materials, organic polymers, inorganic polymers and glass-epoxy composites.

24. A method according to claim 14, wherein said substrate comprises silicon.

25. A method according to claim 14, wherein said cathodic layer comprises at least one material selected from the group consisting of Cu₂S, MoS₂, COₓS_{y} where x=1-4 and y=1-10, COₘOₙ where m=1-2 and n=1-3, WS₂, and mixtures thereof.

26. A microbattery comprising:
a conductive substrate;
a thin film cathodic layer formed on at least one surface of said conductive substrate;
a thin film electrolyte layer formed over said cathodic layer; and
a thin film anodic layer formed over said electrolyte layer.

27. A microbattery according to claim 26 and wherein said cathodic layer comprises an electrochemically formed cathodic layer.

28. A microbattery according to claim 26 and wherein said cathodic layer comprises at least one material selected from the group consisting of sulfides of a transition metal, oxides of a transition metal and mixtures of said sulfides and said oxides.

29. A microbattery according to claim 26 and wherein said conductive substrate comprises:
a non-conductive substrate; and
a conductive layer formed over at least one surface of said non-conductive substrate.

30. A microbattery according to claim 29 and wherein said conductive layer comprises a conductive material electrolessly deposited on said surface of said non-conductive substrate.

31. A microbattery according to claim 29, wherein said conductive layer comprises at least one material selected from the group consisting of Cu, Ni, Co, Fe, Au, Ag, Pd, Pt and their alloys.

32. A microbattery according to claim 26 and also comprising a plurality of cavities formed in said substrate, said cavities having an arbitrary shape and having an aspect ratio greater than 1; and wherein said cathodic layer, said electrolyte layer and said anodic layer are deposited between said cavities and throughout the inner surfaces of said cavities.

33. A microbattery according to claim 32 and wherein said cathodic layer, said electrolyte layer and said anodic layer are continuous.

34. A microbattery according to claim 32, wherein said cavities have an aspect ratio of between 2 to about 50.

35. A microbattery according to claim 32, wherein said cavities have a cylindrical geometry.

36. A microbattery according to claim 26 and wherein said substrate comprises at least one material selected from the group consisting of glass, alumina, semiconductor materials, ceramic materials, organic polymers, inorganic polymers and glass-epoxy composites.

37. A microbattery according to claim 26, wherein said substrate comprises silicon.

38. A microbattery according to claim 26, wherein said cathodic layer comprises at least one material selected from the group consisting of Cu₂S, MOS₂, CoₓS_{y} where x=1-4 and y=1-10, CoₘOₙ where m=1-2 and n=1-3, WS₂, and mixtures thereof.

39. A thin film cathode comprising:
a conductive substrate; and
a thin film cathodic layer electrochemically formed on at least one surface of said conductive substrate.

40. A thin film cathode according to claim 39 and wherein said cathodic layer comprises at least one material selected from the group consisting of sulfides of a transition metal, oxides of a transition metal and mixtures of said sulfides and said oxides.

41. A thin film cathode according to claim 39 and wherein said conductive substrate comprises:
a non-conductive substrate; and
a conductive layer formed over at least one surface of said non-conductive substrate.

42. A thin film cathode according to claim 41 and wherein said conductive layer comprises a conductive material electrolessly deposited on said surface of said non-conductive substrate.

43. A thin film cathode according to claim 41 and wherein said conductive layer comprises at least one material selected from the group consisting of Cu, Ni, Co, Fe, Au, Ag, Pd, Pt and their alloys.

44. A thin film cathode according to claim 39 and also comprising a plurality of cavities formed in said substrate, said cavities having an arbitrary shape and having an aspect ratio greater than 1; and wherein said cathodic layer is deposited between said cavities and throughout the inner surfaces of said cavities.

45. A thin film cathode according to claim 44 and wherein said cathodic layer is continuous.

46. A thin film cathode according to claim 44, wherein said cavities have an aspect ratio of between 2 to about 50.

47. A thin film cathode according to claim 44, wherein said cavities have a cylindrical geometry.

48. A thin film cathode according to claim 39 wherein said substrate comprises at least one material selected from the group consisting of glass, alumina, semiconductor materials, ceramic materials, organic polymers, inorganic polymers and glass-epoxy composites.

49. A thin film cathode according to claim 39, wherein said substrate comprises silicon.

50. A thin film cathode according to claim 39, wherein said cathodic layer comprises at least one material selected from the group consisting of Cu₂S, MoS₂, COₓS_{y} where x=1-4 and y=1-10, CoₘOₙ where m=1-2 and n=1-3, WS₂, and mixtures thereof.
